(19) United States
(12) Patent Application Publication
(10) Pub. No.: US 2014/0017464 A1
(43) Pub. Date: Jan. 16, 2014

(54) BOPP EXTRUDED COATING FILM

(71) Applicants: Feng-Lin Chu, Yun-Meng County (CN); Si-Hua Jiang, Yun-Meng County (CN)

(72) Inventors: Feng-Lin Chu, Yun-Meng County (CN); Si-Hua Jiang, Yun-Meng County (CN)

(73) Assignee: Hubei Firsta Materials Science & Technology Group Co., Ltd, Yun-Meng County (CN)

(21) Appl. No.: 13/594,364

(22) Filed: Aug. 24, 2012

(30) Foreign Application Priority Data
Jul. 10, 2012 (CN) 201210237114.9

(51) Int. Cl. B32B 7/02

(52) U.S. Cl. 428/212

(57) ABSTRACT

A coating film for labels of daily chemicals, beer, cosmetics, beverages, electronic products, and toys. A Biaxially Oriented Polypropylene (BOPP) extruded coating film includes a functional layer, a core layer, and a sub-functional layer. The core layer is located between the functional layer and the sub-functional layer. The functional layer, the core layer, and the sub-functional layer are co-extruded, and then biaxially stretched to form a unity. The weight percentages of the material of the functional layer, the material of the core layer, and the material of the sub-functional layer are 5-20%, 60-90%, and 5-20% respectively. The material of the functional layer is formed by mixing 30-60% of acrylic acid modified polyethylene, 30-45% of a polypropylene block copolymer, 7-20% of C9 hydrogenated petroleum resin, 1-3% of an antioxidant, and 1-2% of a dispersing agent.

### CROSS-REFERENCE TO RELATED APPLICATION

This non-provisional application claims priority under 35 U.S.C. §119(a) on Patent Application No. 201210237114.9 filed in P.R. China on Jul. 10, 2012, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to the technical field of label material, and more specifically to a coating film for labels of daily chemicals, beer, cosmetics, beverages, electronic products, and toys.

### BACKGROUND OF THE INVENTION

The Biaxially Oriented Polypropylene (BOPP) coating film is usable for labels of daily chemicals, beer, cosmetics, beverages, electronic products, and toys. An existing label is formed by coating a functional layer on BOPP off-line, which has the disadvantages that the cost is high, the printing fastness is low, the resistance to wipe is poor, and the printing quality of UV ink flexographic printing, typographical printing and screen printing is poor.

Therefore, a heretofore unaddressed need exists in the art to address the aforementioned deficiencies and inadequacies.

### SUMMARY OF THE INVENTION

In one aspect, the present invention is directed to a BOPP extruded coating film having a low cost, a high printing fastness, and a good resistance to wipe.

In one embodiment, a BOPP extruded coating film according to the present invention includes a functional layer, a core layer, and a sub-functional layer. The core layer is located between the functional layer and the sub-functional layer. The functional layer, the core layer, and the sub-functional layer are co-extruded, and then biaxially stretched to form a unity. The weight percentages of the material of the functional layer, the material of the core layer, and the material of the sub-functional layer are 5-20%, 60-90%, and 5-20% respectively.

The material of the functional layer is formed by mixing acrylic acid modified polyethylene, a polypropylene block copolymer, C9 hydrogenated petroleum resin, an antioxidant, and a dispersing agent. In one embodiment, the weight percentages of the material of the functional layer are 30-60% of acrylic acid modified polyethylene, 30-45% of a polypropylene block copolymer, 7-20% of C9 hydrogenated petroleum resin, 1-3% of an antioxidant, and 1-2% of a dispersing agent.

In a preferred embodiment, the weight percentages of the material of the functional layer, the material of the core layer, and the material of the sub-functional layer are 10%, 80%, and 10% respectively.

In another embodiment, the material of the functional layer further includes 1% by weight percentage of an adhesion promoter.

In yet another embodiment, the acrylic acid modified polyethylene is an acrylic resin or an acrylic copolymer resin.

In a further embodiment, the antioxidant is antioxidant 1010 (pentaerythritol-tetrakis-3-(3,5-di-tert-butyl-4-hydroxyphenyl)-propionate) or antioxidant 1076 (octadecyl-3-(3,5-di-tert-butyl-4-hydroxyphenyl)-propionate).

In another embodiment, the dispersing agent is a dispersing agent (special for BOPP tape) provided by Guangzhou Guanzhi Chemical Co., Ltd., a dispersing agent Disper Ad 3700+ (having enhanced adhesion to BOPP) provided by Shanghai Jinkun Trade Co., Ltd., or a brightening dispersing agent provided by Shanghai Songya Chemical Co., Ltd.

The material of the core layer is formed by mixing polypropylene and propylene-ethylene copolymer. In one embodiment, the weight percentages of the material of the core layer are 80% of polypropylene and 20% of propylene-ethylene copolymer.

The material of the sub-functional layer is formed by mixing a polypropylene copolymer and silicon dioxide (SiO₂). In one embodiment, the weight percentages of the material of the sub-functional layer are 90-99% of a polypropylene copolymer and 1-10% of SiO₂.

In another aspect, the present invention is directed to a method for preparing the BOPP extruded coating film, which includes:

1. Selecting Raw Materials:

(1) selecting the material of the functional layer based on the weight percentages of the raw materials: acrylic acid modified polyethylene 30-60%, polypropylene block copolymer 30-45%, C9 hydrogenated petroleum resin 7-20%, antioxidant 1-3%, and dispersing agent 1-2%;

(2) selecting the material of the core layer based on the weight percentages of the raw materials: polypropylene 80%, and propylene-ethylene copolymer 20%;

(3) selecting the material of the sub-functional layer based on the weight percentages of the raw materials: polypropylene copolymer 90-99%, and SiO₂ 1-10%;

where the material of the functional layer, the material of the core layer, and the material of the sub-functional layer are selected based on the weight percentages of the material of the functional layer 5-20%, the material of the core layer 60-90%, and the material of the sub-functional layer 5-20%; and

2. Extruding the material of the functional layer, the material of the core layer, and the material of the sub-functional layer respectively by 3 extruders to form a functional layer sheet, a core layer sheet, and a sub-functional layer sheet, where the extrusion temperature of the extruder for extruding the functional layer sheet is 220-245° C., the extrusion temperature of the extruder for extruding the core layer sheet is 230-260° C., and the extrusion temperature of the extruder for extruding the sub-functional layer sheet is 230-260° C.;

extruding the extruded functional layer sheet, core layer sheet, and sub-functional layer sheet by a die head into a cast piece (the temperature at the die head is 265° C.), where the core layer sheet is located between the functional layer sheet and the sub-functional layer sheet; and

shaping the cast piece by a sharp cooling roller, and stretching it in a longitudinal direction and a transverse direction into a film, which is subjected to corona treatment, coiled, and finally cut into a BOPP extruded coating film product.

The present invention, among other things, has the following advantages and beneficial effects: (1) one-step extrusion molding, which reduces the expense for further processing (electric charge, labor cost, and material loss), thus having the advantage of low cost; and (2) high printing fastness and good resistance to wipe due to the use of the masterbatch of the BOPP extruded coating film (that is, the material of the functional layer).

The embodiments of the present invention can not only meet the requirements of UV ink flexographic printing, typographical printing and screen printing, but also is useful in cold stamping and hot stamping.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is schematic structural diagram according to one embodiment of the present invention, where 1 represents a functional layer (printed layer), 2 represents a core layer, and 3 represents a sub-functional layer.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

Without intent to limit the scope of the invention, exemplary methods and their related results according to the embodiments of the present invention are given below. Note that titles or subtitles may be used in the examples for convenience of a reader, which in no way should limit the scope of the invention.

### Embodiment 1

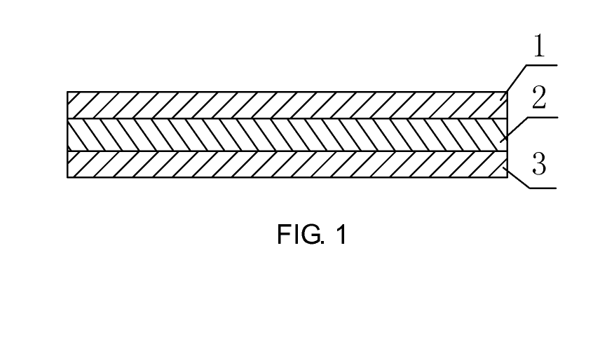

As shown in FIG. 1, a BOPP extruded coating film includes a functional layer 1, a core layer 2, and a sub-functional layer 3. The core layer 2 is located between the functional layer 1 and the sub-functional layer 3. The functional layer 1, the core layer 2, and the sub-functional layer 3 are co-extruded, and then biaxially stretched to form a unity. The weight percentages of the material of the functional layer, the material of the core layer, and the material of the sub-functional layer are 5%, 90%, and 5% respectively.

The material of the functional layer is formed by mixing 30% of acrylic resin (for example, BR-116 from Mitsubishi Rayon Co., Ltd), 45% of a polypropylene block copolymer, 20% of C9 hydrogenated petroleum resin, 3% of an antioxidant, and 2% of a dispersing agent.

The antioxidant is antioxidant 1010 (pentaerythritol-tetrakis-3-(3,5-di-tert-butyl-4-hydroxyphenyl)-propionate).

The dispersing agent is a dispersing agent provided (special for BOPP tape) by Guangzhou Guanzhi Chemical Co., Ltd.

The material of the core layer is formed by mixing 80% of polypropylene and 20% of propylene-ethylene copolymer, based on weight percentage.

The material of the sub-functional layer is formed by mixing 90% of a polypropylene copolymer and 10% of SiO₂, based on weight percentage.

A method for preparing the BOPP extruded coating film includes:

1. selecting raw materials based on the above; and

2. extruding the material of the functional layer, the material of the core layer, and the material of the sub-functional layer respectively by 3 extruders to form a functional layer sheet, a core layer sheet, and a sub-functional layer sheet, where the extrusion temperature of the extruder for extruding the functional layer sheet is 220-245° C., the extrusion temperature of the extruder for extruding the core layer sheet is 230-260° C., and the extrusion temperature of the extruder for extruding the sub-functional layer sheet is 230-260° C.;

extruding the extruded functional layer sheet, core layer sheet, and sub-functional layer sheet by a die head into a cast piece (the temperature at the die head is 265° C.), where the core layer sheet is located between the functional layer sheet and the sub-functional layer sheet; and

shaping the cast piece by a sharp cooling roller, and stretching in a longitudinal direction and a transverse direction into a film, which is subjected to corona treatment, coiled, and finally cut into a product BOPP extruded coating film.

Test of the ink printing fastness of the BOPP extruded coating film of the present invention is as follows.

1. Operation method and steps

(1) Sampling: the sample to be tested is spread on a sampling station, and wiped by a cotton label dipped with a Dyne solution (which is a mixed solution of ethylene glycol ethyl ether and formamide, and is a 30-57 test solution formulated by a tension liquid formulation instrument with ethylene glycol ethyl ether having a surface tension of 30 mN/m and formamide having a surface tension of 57 mN/m mixed at any ratio), a printing surface is determined, and several A4 samples are prepared for printing test.

(2) Turn on a UV drier by the sequence of: connect all power supplies—turn on “Master Switch”-turn on “Transmission”—adjust “Transmission Speed Adjustment”—turn on blower fan—turn on light switch—work. A UV lamp is preheated for 10 to 15 min, and the test is started only after the UV drier is completely preheated. The power of the lamp of the UV drier is 1.0 KW*2 lamps, the irradiation intensity is 80 W/cm, and the peak of the wave is 365 nm.

(3) An ink development machine is set in a start state, and whether the cleanliness of a steel roller and a rubber roller of the ink printer meets requirement is checked (if any dust exists, the test can be started only after the rollers are cleaned with alcohol).

(4) A suitable amount of typographical ink and flexographic ink is coated on an ink homogenizing rubber roller, and the “start” button is pressed, to rotate the ink homogenizing rubber roller and an ink homogenizing chromium roller simultaneously, and uniformly develop the ink 2 times.

(5) A first piece of the prepared A4 samples is removed, a single sample (with the printing surface upward, parallel, and unfolded) is clipped on a pressure roller, the “developing” button is pressed, the pressure roller is stopped after rotating one round, and the sample is removed.

(6) The printed sample is placed on a A4 profile gauge, fixed by a masking tape, then flatly placed on a convey belt of the UV drier, dried two times (the drying times depends on the test) at a rate of 15 m/min, and the sample is removed.

(7) The dried printed sample is horizontally placed on an operation station, a 3M tape (model 810) is tightly attached on the ink side, and stretched upward at an angle of 90 degree, to judge the attachment fastness of the ink. If the ink falls off, it indicates that the fastness is not enough, and if the ink does not fall off, it indicates that the attachment fastness of the ink is high and meets the requirement of customers.

2. After the printing test:

(1) Turn off the UV drier by the sequence of: turn off the UV lamp, continue to supply air for 10 minutes—turn off the air blower—reset—“Transmission Speed Adjustment”—stop “Rotation”—turn off “Master Switch” to turn off the power supply.

(2) Clean the UV printer by the sequence of: press “Cleaning” to clean the steel roller with clean non-fiber cloth dipped with alcohol, after the steel roller is cleaned, press “Cleaning” again, at this time, the steel roller rotates with a black rubber roller, and after cleaning, press the “Stop/Reset” button, and all tests are finished.

The fastness test results of the BOPP extruded coating film according to this embodiment of the present invention are shown in Table 1 below.

TABLE 1
The fastness test results of the BOPP extruded coating film

| | | | BOPP Extruded |
|---|---|---|---|
| | | Common BOPP | Coating Film of the |
| Test item | Test Method | Film | Present Invention |
| Adhesion of UV | The operation method | 100% of the ink | No ink transfer |
| ink | and steps are described in | transfer | |
| | “Operation Guidelines for | | |
| | Ink Printing Operations | | |
| | on BOPP/PET Coating | | |
| | Film” of our company, as | | |
| | disclosed above | | |
| Bar code | Barcode type: code 39 | The adhesion of | The cleaning and |
| printability | Ribbon: All resins Ricoh | the bar code is | adhesion of the bar |
| | B110CR | poor and can be | code are good, and no |
| | Bar code types: routine | easily wiped off, | break point exists |
| | bar code, and fine bar | and break points | |
| | code | exist | |
| Dry friction | Anti-friction instrument | Most of the bar | No abnormity after |
| resistance of bar | | code is wiped off | 100 times of friction |
| code | | | |
| IPA friction | Anti-friction instrument, | Most of the bar | No abnormity after |
| resistance of bar | IPA | code is wiped off | 100 times of friction |
| code | | | |

As shown in Table 1, the present invention has the advantage of high printing fastness.

Test of resistance to wipe of the BOPP extruded coating film according to the embodiment of the present invention: the BOPP extruded coating film is fabricated into a label material (by using the method in related art), a printing surface of the label is subjected to 100-times wiping with alcohol, the pattern on the printing surface is unchanged and the wiped site is not wrinkled and dose not deform. However, a BOPP coating film in the related art is fabricated into a label material, a printing surface of the label is subjected to 100-times wiping with alcohol, the pattern on the printing surface become vague, and the wiped site is wrinkled and deforms. It is suggested that the present invention has the advantage of good resistance to wipe.

An off-line corona value of the polarity of the surface of the film according to the embodiment of the present invention can be up to 56 Dyne, and the one-month corona value can be kept above 50 Dyne (the one-month corona value of a common BOPP coating film can be merely 38 Dyne), so the printability is greatly increased, and the anti-counterfeiting function is achieved due to the resistance to wipe of the film.

In one embodiment, the BOPP extruded coating film according to the present invention is printed on the functional layer, coated with an adhesive on the sub-functional layer, and then attached to a beer bottle as a label of “Beer”. The film is also usable in labels of daily chemicals, cosmetics, beverages, electronic products, and toys.

### Embodiment 2

As shown in FIG. 1, a BOPP extruded coating film includes a functional layer 1, a core layer 2, and a sub-functional layer 3. The core layer 2 is located between the functional layer 1 and the sub-functional layer 3. The functional layer 1, the core layer 2, and the sub-functional layer 3 are co-extruded, and then biaxially stretched to form a unity. The weight percentages of the material of the functional layer, the material of the core layer, and the material of the sub-functional layer are 10%, 80%, and 10% respectively.

The material of the functional layer is formed by mixing 60% of acrylic resin (for example, BR-116 from Mitsubishi Rayon Co., Ltd), 30% of a polypropylene block copolymer, 8% of C9 hydrogenated petroleum resin, 1% of an antioxidant, and 1% of a dispersing agent.

The antioxidant is antioxidant 1010.

The dispersing agent is a dispersing agent Disper Ad 3700+ provided by Shanghai Jinkun Trade Co., Ltd (having enhanced adhesion to BOPP).

The material of the core layer is formed by mixing 80% of polypropylene and 20% of propylene-ethylene copolymer, based on weight percentage.

The material of the sub-functional layer is formed by mixing 95% of a polypropylene copolymer and 5% of SiO₂, based on weight percentage.

A method for preparing the BOPP extruded coating film includes:

1. selecting raw materials based on the above; and

2. extruding the material of the functional layer, the material of the core layer, and the material of the sub-functional layer respectively by 3 extruders to form a functional layer sheet, a core layer sheet, and a sub-functional layer sheet, where the extrusion temperature of the extruder for extruding the functional layer sheet is 220-245° C., the extrusion temperature of the extruder for extruding the core layer sheet is 230-260° C., and the extrusion temperature of the extruder for extruding the sub-functional layer sheet is 230-260° C.;

extruding the extruded functional layer sheet, core layer sheet, and sub-functional layer sheet by a die head into a cast piece (the temperature at the die head is 265° C.), where the core layer sheet is located between the functional layer sheet and the sub-functional layer sheet; and

shaping the cast piece by a sharp cooling roller, and stretching in a longitudinal direction and a transverse direction into a film, which is subjected to corona treatment, coiled, and finally cut into a product BOPP extruded coating film.

The BOPP extruded coating film according to the embodiment of the present invention is subjected to a printing fastness test as described in Embodiment 1, and the test results are the same as those in Embodiment 1. It is suggested that the present invention, among other things, has the advantage of high printing fastness.

The BOPP extruded coating film according to the embodiment of the present invention is subjected to a test of resistance to wipe. The BOPP extruded coating film is fabricated into a label material (by using the method in related art), a printing surface of the label is subjected to 100-times wiping with alcohol, the pattern on the printing surface is unchanged and the wiped site is not wrinkled and dose not deform; and a BOPP coating film in the related art is fabricated into label material, a printing surface of the label is subjected to 100-times wiping with alcohol, the pattern on the printing surface become vague, and the wiped site is wrinkled and deforms. It is suggested that the present invention, among other things, has the advantage of good resistance to wipe.

An off-line corona value of the polarity of the surface of the film according to the embodiment of the present invention can be up to 56 Dyne, and the one-month corona value can be kept above 50 Dyne (the one-month corona value of a common BOPP coating film can be merely 38 Dyne), so the printability is greatly increased, and the anti-counterfeiting function is achieved due to the resistance to wipe of the film.

In one embodiment, the BOPP extruded coating film of the present invention is printed on the functional layer, coated with an adhesive on the sub-functional layer, and then attached to a beer bottle as a label of “Beer”. The film is also usable in labels of daily chemicals, cosmetics, beverages, electronic products, and toys.

### Embodiment 3

As shown in FIG. 1, a BOPP extruded coating film includes a functional layer 1, a core layer 2, and a sub-functional layer 3. The core layer 2 is located between the functional layer 1 and the sub-functional layer 3. The functional layer 1, the core layer 2, and the sub-functional layer 3 are co-extruded, and then biaxially stretched to form a unity. The weight percentages of the material of the functional layer, the material of the core layer, and the material of the sub-functional layer are 20%, 60%, and 20% respectively.

The material of the functional layer is formed by mixing 40% of acrylic resin (for example, BR-116 from Mitsubishi Rayon Co., Ltd), 40% of a polypropylene block copolymer, 16% of C9 hydrogenated petroleum resin, 2% of an antioxidant, and 2% of a dispersing agent.

The antioxidant is antioxidant 1076 (octadecyl-3-(3,5-di-tert-butyl-4-hydroxyphenyl)-propionate).

The dispersing agent is a brightening dispersing agent provided by Shanghai Songya Chemical Co., Ltd.

The material of the core layer is formed by mixing 80% of polypropylene and 20% of propylene-ethylene copolymer, based on weight percentage.

The material of the sub-functional layer is formed by mixing 99% of a polypropylene copolymer and 1% of SiO₂, based on weight percentage.

A method for preparing the BOPP extruded coating film includes:

1. selection of raw materials based on the above; and

2. extruding the material of the functional layer, the material of the core layer, and the material of the sub-functional layer respectively by 3 extruders to form a functional layer sheet, a core layer sheet, and a sub-functional layer sheet, where the extrusion temperature of the extruder for extruding the functional layer sheet is 220-245° C., the extrusion temperature of the extruder for extruding the core layer sheet is 230-260° C., and the extrusion temperature of the extruder for extruding the sub-functional layer sheet is 230-260° C.;

extruding the extruded functional layer sheet, core layer sheet, and sub-functional layer sheet by a die head into a cast piece (the temperature at the die head is 265° C.), where the core layer sheet is located between the functional layer sheet and the sub-functional layer sheet; and shaping the cast piece by a sharp cooling roller, and stretching in a longitudinal direction and a transverse direction into a film, which is subjected to corona treatment, coiled, and finally cut into a product BOPP extruded coating film.

The BOPP extruded coating film according to the embodiment of the present invention is subjected to a printing fastness test as described in Embodiment 1, and the test results are the same as those in Embodiment 1. It is suggested that the present invention, among other things, has the advantage of high printing fastness.

The BOPP extruded coating film according to the embodiment of the present invention is subjected to a resistance to wipe test. The BOPP extruded coating film is fabricated into a label material (by using the method in related art), a printing surface of the label is subjected to repeated wipe of 100 times with alcohol, the pattern on the printing surface is unchanged and the wiped site is not wrinkled and dose not deform. However, a BOPP coating film in the related art is fabricated into label material, a printing surface of the label is subjected to repeated wipe of 100 times with alcohol, the pattern on the printing surface become vague, and the wiped site is wrinkled and deforms. It is suggested that the present invention has the advantage of good resistance to wipe.

An off-line corona value of the polarity of the surface of the film according to the embodiment of the present invention can be up to 56 Dyne, and the one-month corona value can be kept above 50 Dyne (the one-month corona value of a common BOPP coating film can be merely 38 Dyne), so the printability is greatly increased, and the anti-counterfeiting function is achieved due to the resistance to wipe of the film.

### Embodiment 4

As shown in FIG. 1, a BOPP extruded coating film includes a functional layer 1, a core layer 2, and a sub-functional layer 3. The core layer 2 is located between the functional layer 1 and the sub-functional layer 3. The functional layer 1, the core layer 2, and the sub-functional layer 3 are co-extruded, and then biaxially stretched to form a unity. The weight percentages of the material of the functional layer, the material of the core layer, and the material of the sub-functional layer are 10%, 80%, and 10% respectively.

The material of the functional layer is formed by mixing 40% of acrylic resin (for example, BR-116 from Mitsubishi Rayon Co., Ltd), 40% of a polypropylene block copolymer, 16% of C9 hydrogenated petroleum resin, 2% of an antioxidant, and 2% of a dispersing agent.

The antioxidant is antioxidant 1076.

The dispersing agent is a dispersing agent (special for BOPP tape) provided by GuangZhou GuanZhi ChemiCal Co., Ltd.

The material of the core layer is formed by mixing 80% of polypropylene and 20% of propylene-ethylene copolymer, based on weight percentage.

The material of the sub-functional layer is formed by mixing 94% of a polypropylene copolymer and 6% of SiO₂, based on weight percentage.

A method for preparing the BOPP extruded coating film includes:

1. selecting raw materials based on the above; and

2. extruding the material of the functional layer, the material of the core layer, and the material of the sub-functional layer respectively by 3 extruders to form a functional layer sheet, a core layer sheet, and a sub-functional layer sheet, where the extrusion temperature of the extruder for extruding the functional layer sheet is 220-245° C., the extrusion temperature of the extruder for extruding the core layer sheet is 230-260° C., and the extrusion temperature of the extruder for extruding the sub-functional layer sheet is 230-260° C.;

extruding the extruded functional layer sheet, core layer sheet, and sub-functional layer sheet by a die head into a cast piece (the temperature at the die head is 265° C.), where the core layer sheet is located between the functional layer sheet and the sub-functional layer sheet; and

shaping the cast piece by a sharp cooling roller, and stretching in a longitudinal direction and a transverse direction into a film, which is subjected to corona treatment, coiled, and finally cut into a product BOPP extruded coating film.

The BOPP extruded coating film according to the embodiment of the present invention is subjected to a printing fastness test as described in Embodiment 1, and the test results are the same as those in Embodiment 1. It is suggested that the present invention has the advantage of high printing fastness.

The BOPP extruded coating film according to the embodiment of the present invention is subjected to a resistance to wipe test. The BOPP extruded coating film is fabricated into a label material (by using the method in related art), a printing surface of the label is subjected to repeated wipe of 100 times with alcohol, the pattern on the printing surface is unchanged and the wiped site is not wrinkled and dose not deform. A BOPP coating film in the related art is fabricated into label material, a printing surface of the label is subjected to repeated wipe of 100 times with alcohol, the pattern on the printing surface become vague, and the wiped site is wrinkled and deforms. It is suggested that the present invention has the advantage of good resistance to wipe.

An off-line corona value of the polarity of the surface of the film according to the embodiment of the present invention can be up to 56 Dyne, and the one-month corona value can be kept above 50 Dyne (the one-month corona value of a common BOPP coating film can be merely 38 Dyne), so the printability is greatly increased, and the anti-counterfeiting function is achieved due to the resistance to wipe of the film.

### Embodiment 5

The embodiment is substantially the same as Embodiment 1, except that the material of the functional layer is formed by mixing 30% of acrylic resin (for example, BR-116 from Mitsubishi Rayon Co., Ltd), 45% of a polypropylene block copolymer, 19% of C9 hydrogenated petroleum resin, 3% of an antioxidant, 2% of a dispersing agent, and 1% of an adhesion promoter (Nanjing Pinning Coupling Agent Co., Ltd., adhesion promoter PN-800).

The BOPP extruded coating film according to the embodiment of the present invention is subjected to a printing fastness test as described in Embodiment 1, and the test results are the same as those in Embodiment 1. It is suggested that the present invention has the advantage of high printing fastness.

The BOPP extruded coating film according to the embodiment of the present invention is subjected to a resistance to wipe test. The BOPP extruded coating film is fabricated into a label material (by using the method in related art), a printing surface of the label is subjected to repeated wipe of 100 times with alcohol, the pattern on the printing surface is unchanged and the wiped site is not wrinkled and dose not deform. However, a BOPP coating film in the related art is fabricated into label material, a printing surface of the label is subjected to repeated wipe of 100 times with alcohol, the pattern on the printing surface become vague, and the wiped site is wrinkled and deforms. It is suggested that the present invention has the advantage of good resistance to wipe.

An off-line corona value of the polarity of the surface of the film according to the embodiment of the present invention can be up to 56 Dyne, and the one-month corona value can be kept above 50 Dyne (the one-month corona value of a common BOPP coating film can be merely 38 Dyne), so the printability is greatly increased, and the anti-counterfeiting function is achieved due to the resistance to wipe of the film.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### Embodiment 6

The embodiment is substantially the same as Embodiment 2, except that the material of the functional layer is formed by mixing 60% of acrylic resin (for example, BR-116 from Mitsubishi Rayon Co., Ltd), 30% of a polypropylene block copolymer, 8% of C9 hydrogenated petroleum resin, 1% of an antioxidant, 1% of a dispersing agent, and 1% of an adhesion promoter (adhesion promoter PN-800 from Nanjing Pinning Coupling Agent Co., Ltd.).

The BOPP extruded coating film according to the embodiment of the present invention is subjected to a printing fastness test as described in Embodiment 1, and the test results are the same as those in Embodiment 1. It is suggested that the present invention, has the advantage of high printing fastness.

The BOPP extruded coating film according to the embodiment of the present invention is subjected to a resistance to wipe test. The BOPP extruded coating film is fabricated into a label material (by using the method in related art), a printing surface of the label is subjected to repeated wipe of 100 times with alcohol, the pattern on the printing surface is unchanged and the wiped site is not wrinkled and dose not deform. A BOPP coating film in the related art is fabricated into label material, a printing surface of the label is subjected to repeated wipe of 100 times with alcohol, the pattern on the printing surface become vague, and the wiped site is wrinkled and deforms. It is suggested that the present invention, has the advantage of good resistance to wipe.

An offline corona value of the polarity of the surface of the film according to the embodiment of the present invention can be up to 56 Dyne, and the one-month corona value can be kept above 50 Dyne (the one-month corona value of a common BOPP coating film can be merely 38 Dyne), so the printability is greatly increased, and the anti-counterfeiting function is achieved due to the resistance to wipe of the film.

The present invention can be implemented with raw materials (including raw materials of different molecule weight and available from different manufacturers) mentioned in the present invention, and the embodiments are not enumerated.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A Biaxially Oriented Polypropylene (BOPP) extruded coating film, comprising:
a functional layer,
a core layer, and
a sub-functional layer,
wherein the core layer is located between the functional layer and the sub-functional layer, and the functional layer, the core layer, and the sub-functional layer are co-extruded, and then biaxially stretched to form a unity;
wherein the weight percentages of the material of the functional layer, the material of the core layer, and the material of the sub-functional layer are 10%, 80%, and 10% respectively;
wherein the material of the functional layer is formed by mixing 60% of acrylic resin, 30% of a polypropylene block copolymer, 8% of C9 hydrogenated petroleum resin, 1% of an antioxidant, and 1% of a dispersing agent, based on weight percentage;
wherein the material of the core layer is formed by mixing 80% of polypropylene and 20% of propylene-ethylene copolymer, based on weight percentage; and
wherein the material of the sub-functional layer is formed by mixing 95% of a polypropylene copolymer and 5% of SiO₂, based on weight percentage.

2. A Biaxially Oriented Polypropylene (BOPP) extruded coating film, comprising:
a functional layer,
a core layer, and
a sub-functional layer,
wherein the core layer is located between the functional layer and the sub-functional layer, and the functional layer, the core layer, and the sub-functional layer are co-extruded, and then biaxially stretched to form a unity;
wherein the weight percentages of the material of the functional layer, the material of the core layer, and the material of the sub-functional layer are 10%, 80%, and 10% respectively; and
wherein the material of the functional layer is formed by mixing 30-60% of acrylic acid modified polyethylene, 30-45% of a polypropylene block copolymer, 7-20% of C9 hydrogenated petroleum resin, 1-3% of an antioxidant, 1-2% of a dispersing agent, based on weight percentage.

3. The BOPP extruded coating film according to claim 2, wherein the material of the functional layer further comprises 1% by weight percentage of an adhesion promoter.

4. The BOPP extruded coating film according to claim 2, wherein the acrylic acid modified polyethylene is an acrylic resin or an acrylic copolymer resin.

5. The BOPP extruded coating film according to claim 2, wherein the antioxidant is pentaerythritol-tetrakis-3-(3,5-di-tert-butyl-4-hydroxyphenyl)-propionate or octadecyl-3-(3,5-di-tert-butyl-4-hydroxyphenyl)-propionate.

6. The BOPP extruded coating film according to claim 2, wherein the material of the core layer is formed by mixing 80% of polypropylene and 20% of propylene-ethylene copolymer, based on weight percentage.

7. The BOPP extruded coating film according to claim 2, wherein the material of the sub-functional layer is formed by mixing 90-99% of a polypropylene copolymer and 1-10% of SiO₂, based on weight percentage.

8. A Biaxially Oriented Polypropylene (BOPP) extruded coating film, comprising:
a functional layer,
a core layer, and
a sub-functional layer,
wherein the core layer is located between the functional layer and the sub-functional layer, and the functional layer, the core layer, and the sub-functional layer are co-extruded, and then biaxially stretched to form a unity;
wherein the weight percentages of the material of the functional layer, the material of the core layer, and the material of the sub-functional layer are 5-20%, 60-90%, and 5-20% respectively; and
wherein the material of the functional layer is formed by mixing 30-60% of acrylic acid modified polyethylene, 30-45% of a polypropylene block copolymer, 7-20% of C9 hydrogenated petroleum resin, 1-3% of an antioxidant, 1-2% of a dispersing agent, based on weight percentage.

9. The BOPP extruded coating film according to claim 8, wherein the material of the functional layer further comprises 1% by weight percentage of an adhesion promoter.

10. The BOPP extruded coating film according to claim 8, wherein the acrylic acid modified polyethylene is an acrylic resin or an acrylic copolymer resin.

11. The BOPP extruded coating film according to claim 8, wherein the antioxidant is pentaerythritol-tetrakis-3-(3,5-di-tert-butyl-4-hydroxyphenyl)-propionate or octadecyl-3-(3,5-di-tert-butyl-4-hydroxyphenyl)-propionate.

12. The BOPP extruded coating film according to claim 8, wherein the material of the core layer is formed by mixing 80% of polypropylene and 20% of propylene-ethylene copolymer, based on weight percentage.

13. The BOPP extruded coating film according to claim 8, wherein the material of the sub-functional layer is formed by mixing 90-99% of a polypropylene copolymer and 1-10% of SiO₂, based on weight percentage.
